(19) United States
(12) Patent Application Publication
(10) Pub. No.: US 2008/0235634 A1
(43) Pub. Date: Sep. 25, 2008

(54) ELECTRONIC PAPER DEVICE FOR USE BY AIRCRAFT PILOTS AND CREW

(75) Inventor: Rolf STEFANI, West River, MD (US)

Correspondence Address: PRASS & IRVING, LLP, 2661 Riva Road, Bldg. 1000, Suite 1044, ANNAPOLIS, MD, 21401, US

(73) Assignee: ARINC Incorporated, Annapolis, MD (US)

(21) Appl. No.: 11/755,350

(22) Filed: May 30, 2007

Related U.S. Application Data
(60) Provisional application No. 60/896,484, filed on Mar. 22, 2007.

(51) Int. Cl. G06F 3/14

(52) U.S. Cl. 715/866; 345/179

(57) ABSTRACT

An electronic paper device is disclosed for use by aircraft pilots and crew. The electronic paper device may include a communication interface that facilitates downloading of aviation-related documents, the aviation-related documents being and available for downloaded prior to each flight, a memory that stores the aviation-related documents, a user interface that facilitates access and use of the aviation-related documents by a user, and an electronic paper display that displays the aviation-related documents to the user in a manner that permits viewing in all lighting conditions.

### PRIORITY INFORMATION

This non-provisional application claims priority from U.S. provisional application Ser. No. 60/896,484, filed Mar. 22, 2007, the content of which is incorporated by reference in its entirety.

### BACKGROUND OF THE DISCLOSURE

1. Field of the Disclosure

The disclosure relates to applications for e-paper devices.

2. Introduction

The personal computer based devices in aircraft are a relatively new advance in aviation. The typical PC/notebook or tablet computer proposed today is not generally networked or connected to content management systems necessary to guarantee the validity and integrity of the data. Secondly, current shortcomings of conventional portable PC type of technology limit their actual usefulness and ability to be of great value.

There are numerous EFB types of systems implemented ranging from Class 3 fully integrated into the flight deck down to Class 1 devices that are portable. (See e.g., FAA 120-76A guidelines for computing devices in aircraft). They all feature LCD technology and suffer from technical limitations. These technical problems have yet to be addressed or solved in any known product.

### SUMMARY OF THE DISCLOSURE

An electronic paper device is disclosed for use by aircraft pilots and crew. The electronic paper device may include a communication interface that facilitates downloading of aviation-related documents, the aviation-related documents being and available for download prior to each flight, a memory that stores the aviation-related documents, a user interface that facilitates access and use of the aviation-related documents by a user, and an electronic paper display that displays the aviation-related documents to the user in a manner that permits viewing in lighting conditions similar to that required of paper (including bright light).

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary eFlyBook network system diagram in accordance with a possible embodiment of the disclosure;

FIG. 2 illustrates an exemplary eFlyBook in accordance with a possible embodiment of the disclosure;

FIG. 3 illustrates a block diagram of an exemplary eFlyBook in accordance with a possible embodiment of the disclosure; and

FIG. 4 is an exemplary flowchart illustrating one possible eFlyBook implementation process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure. Note that while this disclosure discusses aircraft and airline uses for the disclosure, the disclosure is by no means limited to that area and may be applied to a wide variety of environment and uses.

This disclosure concerns targeted products and services developed to provide electronic paper based computing devices and highly automated systems which will reduce the need for and use of paper in three very specific Aviation market segments. Although, aviation applications are discussed herein, the disclosure is not limited to those applications and may be applied to other industries and businesses.

As background, all pilots and airline cabin crew are required to readily have certain technical, reference, procedural policies and information available at all times. They also require capabilities to perform certain operational computations in order to determine safe flight parameters. Today, the informational access requirement is accomplished by various complex documentation systems and processes both in paper as well as thru the use of newer, digital documentation and publishing systems. These systems attempt to deliver documents to electronic display systems, such as Electronic Flight Bags (EFB). The computational requirement is also being fulfilled in various ways such as by the utilization of on-board dedicated electronic devices in order to perform the computations as well as by the use of paper based forms much like spreadsheets.

The problems with conventional systems are many and interwoven. For the on-board paper documentation utilization model:
Documents are very heavy and require expenditure of fuel which airlines would rather dedicate to lifting revenue producing cargo or passengers,
Pilot back injuries have occurred due to the weight of their flight bags. In many cases the flight bags may weigh more than 70 pounds,
Timeliness of new data is compromised due to the difficulty of distributing new paper documents,
Airline cost in producing new paper versions. Cost in paper and manpower required to deliver the paper to aircraft or individuals requiring the updates,
Storage for massive paper volumes on the aircraft,
Inability for airline management to distribute near real-time information such as NOTAMS or Read Before Fly (RBF) data to affected crew members,
Inability to account for the distribution of data/information,
Paper based documentation is very labor intensive and time consuming to produce, and
There is no way to annotate documents and communicate these back easily.

Problems and shortcomings of existing electronic based document display systems are mostly technology based. They include:
Very expensive cost of electronics. Particularly due to their non portable nature, certain certification requirements make them extremely expensive to implement,
PC technology such as tablet electronic devices are;
   Very expensive,
   Require being connected to aircraft power—limited battery life,
   Do not work well (if at all) in sunlight saturated aircraft cockpits,
   Viewing angles are very limited by LCD technology,
   Are far too bright for use at night in a dark cockpit,
   Devices are large and heavy, produce heat,
User interface designs and implementations are too complex and require significant training,
Typically there is no seamless integration of devices to a content management system,
Are not removable from the aircraft,
Cannot be used by individuals away from the aircraft.

Current systems and methods are not easily implemented. The return on investment required to make economic sense for an airline in order to implement systems that marginally fulfill their needs has stalled acceptance of PC based electronic platforms in most operations.

Thus, unique attributes of the eFlyBook hardware disclosed herein, overcomes all of the technical limitations of LCD based electronic display devices coupled with a complete system and services offering to serve as an attractive means to a customer desired end state of reducing or virtually, eliminating paper on aircraft.

An interesting comparison can be made between an eFlyBook type of device (under $1,000 per user) and an integrated class 3 EFB technology in newer airlines which can cost more than $200,000 per display in the cockpit. The class 3 EFB systems are not only paper replacement devices, they perform many additional cockpit functions such as provide for moving map etc. The main notion is that eFlyBook can perform (relating to paper) much better at a small fraction of the price and is not designed to perform multiple functionalities other than document viewing/management, calculations, and electronic updates/messages. This is due to the idea that the eFlyBook is targeted at replacing paper with as close to paper functionality as possible (which can only be accomplished with e-paper based technology) and providing pilots and crew with the appropriate functional user interface required.

The other described problem relating to stand alone computing devices used to perform operational calculations, mirror the problems described above in implementing LCD based electronic devices in the cockpit. Integrating the computational capability on the eFlyBook overcomes all of the technical limitations to which a tablet PC suffers.

This disclosure describes products and services developed to provide electronic paper based computing devices and highly automated systems which will reduce the need for and use of paper in the Aviation market segments.

The products and services shown below are all based on the same core technology (device and automated content management system) but may have different user interface designs and content distribution architectures and capabilities that differentiate the product and systems from each other.

eFlyBook™—General Aviation (GA) Pilot targeted device. Content, GUI and service to deliver content suited specifically for GA Pilots. Includes Maps, Charts, FAA Documents and other subscriptions relevant to the GA Pilot.

eFlyBook™-Crew version—Commercial Airline Crew targeted device. Content, GUI and service to be utilized by the cabin crew in numerous ways. For example, a document reader for airline crew manuals (i.e. FCOM; a form fill device for operational forms; an eTechlog input form for malfunctions and reporting. etc.; a point of sale terminal, etc.

The e-paper based products and services discussed herein facilitate user interaction with digital versions of conventional paper documents and reference material needed to conduct airline flight operations safely. A critical attribute of all flight critical information is that it must always be accurate and current. The software and system capabilities imbedded within the eFlyBook suite of products and services that provide automated and interactive methods of ensuring information can be displayed on eFlyBook devices, are easy to interact with and provide information that is valid and more current than any other comparable aviation product available.

The eFlyBook is a modular, integrated hardware and software system that provides a completely scaleable architecture enabling airlines with the flexibility to choose solutions that fit their needs. By implementing eFlyBook products and services, airlines will be able to help reduce their costs, improve flight deck safety, and establish convenient access to digital documents while being digitally connected to their dispatch and host processing systems as required to acquire updates critical to flight safety.

The eFlyBook system may include necessary airborne (or user/pilot assigned) hardware components, software modules and communications capabilities that enable the mobile aircraft to interact and share data with ground based systems as needed. The eFlyBook provides a device, integrated system and content management that will provide the flight crew with access to all traditionally paper based capabilities on a portable e-paper based device. The capabilities include interactive computational and data intensive activities traditionally accomplished manually on paper or on other computing devices.

The highly tailored and device specific user interface incorporated into the eFlyBook software carefully exploits the attributes of the e-paper device in order to deliver simple and easy-to-use functionality. The eFlyBook has many unique physical attributes, such as providing the first aviation system that could actually be used in a sun filled cockpit. While many other technologies have been developed with the same objective of providing a tool for the pilot to use in the cockpit, all fell short on basic requirements, such as long power life, easy-to-use interface, viewing in sunlight, portability, and a practical size for use in a cockpit.

The eFlyBook product was designed and released to provide the platform and custom user interface to allow GA pilots to access the above mentioned documents in a simple and easy manner. The solution also incorporates an automated communications enabled method of obtaining new versions of the software and specific content as needed. This unique integrated content management system is functioning as part of the GA product and services delivered. It is the backbone of the automated content delivery system in place for the GA eFlyBook product.

The system ensures that necessary software updates and aviation content are delivered to end users as required. Aviation content such as approach plates are updated by the FAA on a 28 day cycle and are extensive in volume. The aforementioned delivery system described accomplishes the dissemination of these documents.

### Flight Crew Document Interaction Device and Services

The other specific aviation related product under development fulfills dual roles. The eFlyBookCrew named product can be configured and used by the flight crew and/or the flight attendants. Similar in functionality, the flight crew device incorporates specific flight operations software used by the flight crew in calculating certain operational parameters.

The technical features and capabilities of the eFlyBook fulfill the needs that have been virtually unattainable in the effort to reduce dependency on paper in the airline industry. Paper is expensive to produce, difficult to manage and distribute, and is costly to carry (weight penalty).

The eFlyBook-Crew product and complete service package (including end-to-end content management) is a paradigm shift from conventional laptop based approaches to hosting needed documents. A tailored user interface, purposely designed to be intuitive and easy to use coupled with simple to manage distribution and acquisition of content make this new method of interacting with information, typically paper based, a reality.

Modular software design and architecture allow the device and system to be easily tailored to meet the wide array of various customer requirements quickly and inexpensively.

The eFlyBook-Crew product and system is more than a document reader system. It is a complete Information Management system. The vast amount of information required by cabin and flight crews encompasses dynamic information, such as passenger information for any given flight, to documents describing technical features of the aircraft. The eFlyBook can accommodate this broad information need in a single device.

The cabin crew can easily replace many pounds of paper on the 12 ounce eFlyBook device. Weight savings and easy access to information are clear advantages. In today's airline environment it is typical that each flight attendant is assigned and carries their own set of appropriate documentation. Some flight specific documentation is printed last minute and placed on board the aircraft before departure.

Cabin Crew Ops Concept:
The operational concept of the eFlyBook-crew product is that each employee is assigned and carries their own device with them at all times.
The device content is automatically updated as appropriate. Updates are manually initiated by the device owner using wireless IP type of communications.
Dynamic flight information can be uploaded to each device immediately before a flight departs.
New features can be added to the device via the content management system as they become available and will reduce training requirements due to the commonality of the user interface.

### POS Functionality

Besides reducing onboard paper, there is a significant trend in the airline industry to provide for acceptance of credit cards for payment for a number of services and products offered to customers in flight. The eFlyBook, as a processing platform, allows us to integrate a magnetic card strip reader into the device as an optional component. This integration and custom tailored application used to process credit card data, and ultimately to use the eFlyBook communications networks to validate credit card information, is a compelling, additional benefit to implementing an eFlyBook based system.

When coupled with the eFlyBook communications infrastructure, such as GateLink or SATCOM, reductions in credit card losses can be realized as well as automated inventory control systems can be easily implemented. The key to successful implementation includes the criteria of low possibility of mistakes and reliability. These issues are mitigated by a consistent user interface and a sound technical architecture.

### Flight Crew—Pilot Use

The following describes the eFlyBook-Crew product and system for Flight (cockpit) crew utilization. The pilot/flight crew product and capabilities discussed were developed based on input from actual commercial airlines. Demonstrations of the GA version of the eFlyBook have been made to a number of airlines and their ideas and requirements were considered to aid in the design of the crew version of the product.

The massive amount of paper required to be carried by pilots can weigh in at more than 70 pounds per pilot. Extrapolating the weight savings benefits is an attractive reason on its own to implement such a product. For example, if an aircraft is carrying two pilots (conservatively speaking) on a single flight, then more than 140 pounds of paper will be transported as well. That's almost equivalent to carrying one extra passenger per flight!

Other operational advantages such as calculation potential and automatic delivery of digital content as published (and associated reduced costs in manpower and paper), enhance the cost benefit of the system.

Cockpit Use Ops Concept:
Keeping with the concept of operations that was described for the Cabin Crew product, each cockpit crew member would have a device assigned to them individually. There may be spares available at certain dispatch offices or even one per aircraft that can be quickly re-configured to use as a backup if necessary.
All paper products, with the exception of charts and maps, could be hosted in digital format on their device.
Airlines would have access to the content management system to publish and release documents for automatic distribution as necessary.
Airlines would have visibility regarding the status of all device content, knowing, for instance, if a message was delivered to a group of devices on time.

The modular architecture lends itself to adding new functionality without being overly disruptive. New software and documents can be installed and distributed using a tailored content management server system.

### Flight Crew Content Management

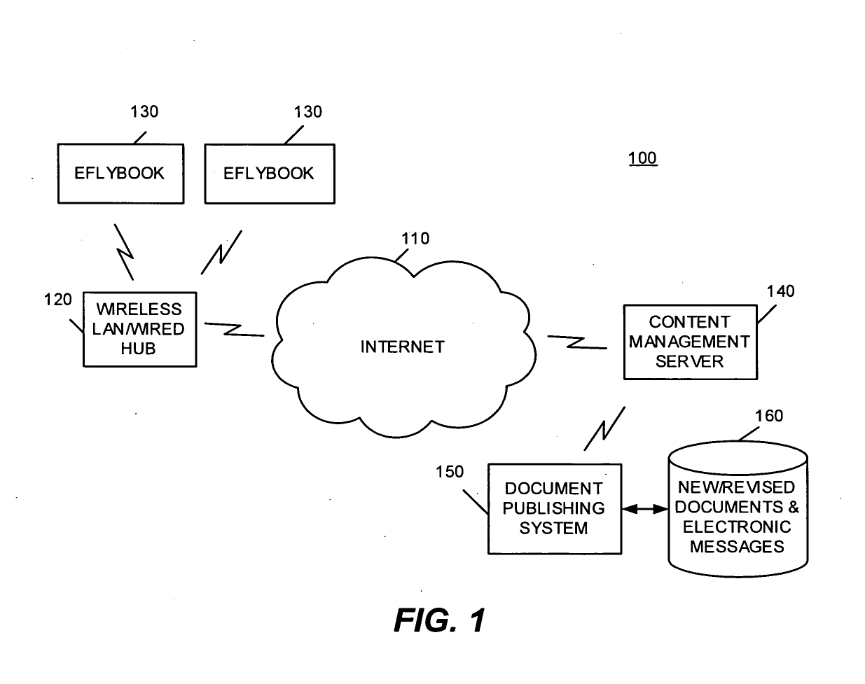

FIG. 1 illustrates an exemplary eFlyBook network system 100 diagram in accordance with a possible embodiment of the disclosure.

eFlyBook system 100 may include wired local area network (LAN)/wired hub 120 and content management server 140 connected to the Internet 110. Wireless land/wired hub 120 may be connected to eFlyBooks 130 and content management server 140 may be connected to document publishing system 150 which is then connected to new/revised documents and electronic messages database 160. Although the connections in FIG. 1 are shown as wireless configuration, one or more of these connections may be wired.

Wireless land/wired hub 120 may represent any land, hub, router, switch, server, computer, or any other device that may serve as an intermediate communication routing device between the Internet 110 and eFlyBooks 130. Content management server 140 may be any server, computer or other similar device capable of storing and managing aviation publications and other documents and products. Document publishing system 150 may serve as the aviation document and publication source for commercial and private aviation entities, including aircraft and crew, ground services, air traffic control, flight operations, etc. New/revised documents and electronic message database 160 may serve to store up-to-date documents, publications and products, and Read-Before-Flight (RBF) information, such as airport approach plates, NOTAMS, runway charts, airway charts, etc.

For example, the content features of an eFlyBook 130 for use in a GA cockpit may include the following.

1. Terminal Approach Procedures

2. Airport Facility Directory

3. Low and High Altitude Enroute Charts

4. FAA FAR/AIM documents

The types of data used by flight crews that may be downloaded and stored on the eFlyBook 130 may include; ops manuals, technical manuals, emergency procedures, instructions manuals, MEL/CDL documents, training manuals, etc.

An alternate approach to content management may be required because the devices being assigned to individuals instead of an aircraft dictate that their content must be able to be updated from basically any internet connection available. On aircraft or off.

The eFlyBook 130 may feature two-way communications via an integrated WiFi transceiver as well as via a wired internet connection thru the associated power, USB and internet adapter. The eFlyBook 130 can be considered to create an IP based secure internet connection back to an appropriately configured content management server 140, either hosted or one integrated into the eFlyBook network 100 or a customer's own Intranet.

The customer airline can publish new content for a specific device, group of devices or all devices in their system to receive the new content the next time that the user initiates a connection over the Internet 110. The content management server 140 may also allow the customer to generate status reports describing available device statistics such as successful updates including durations and time parameters.

The user interface for content management on the eFlyBook 130 may provide simplicity, ease of use, and also protect against inadvertent activation. A simple exemplary four-step procedure may be used that provides adequate warnings, prompts and immediate feedback to the user during all steps of the process. The sequence may be aborted by the user at any time by pressing a connect/disconnect button and confirming a desire to end the current session.

Once a session has begun, the user may be provided with an indication about what new content is available and have the opportunity to select the data he wishes to receive or send during the session. This capability allows the user to manually and consciously determine if the time they have available for the session is adequate to transfer data at the moment. For example, if the pilot is at an airport and has only a 20 minute window before the flight must depart, the user may note that one of the specific document's size requires a 22 minute connection, he may choose to download the data at another time when there is a longer window of opportunity. These types of features may be configurable by the system manager and may be configured so as not to allow this specific choice.

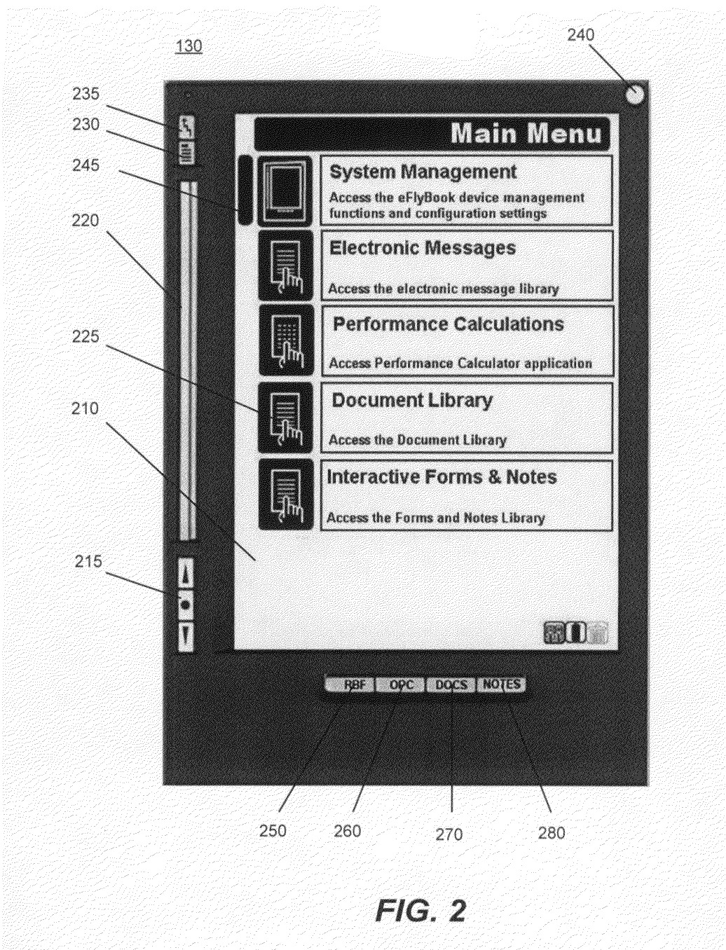

FIG. 2 illustrates an exemplary eFlyBook 130 in accordance with a possible embodiment of the disclosure. eFlyBook 130 may include several user interface buttons and screens to facilitate the user's interaction with the device and its content. For example, the eFlyBook 130 may include a display screen 210 that presents information, menus, and selections 225 to the user, scroll and select buttons 215, page left/right bar 220, main menu button 230, back button 235, cursor 245, WiFi connect 240, and a plurality of main function buttons, including electronic messages button 250, operational performance (OPC) button 260, document library button 270, and interactive form and notes button 280. A user may make selections using the hard button or soft buttons by using a stylus on the display screen 210, for example. Please note that the buttons and screen displays shown are merely exemplary, and can be modified to meet the needs of aircraft and crew in accordance with methods known to one of skill in the art.

The display screen 210 may be an eletrophoretic (ePaper) display that possesses a paper-like high-contrast appearance, ultra low power consumption, and a thin, light form. The ePaper display gives the viewer the experience of reading from paper while having the ability to receive electronic updates. The ePaper display is enabled by “electronic ink” which is essentially pigments that carry a charge enabling a display to be updated through electronics in order to produce an image. Electronic ink is ideally suited for ePaper as it is a reflective technology which requires no front or back light and is viewable under a wide range of lighting conditions, including direct sunlight, and requires no power to maintain an image.

The eFlyBook 130 features two-way communications via an integrated WiFi transceiver 240 as well as a wired Internet connection through the associated power, USB, and internet adapter (not shown). The device can be considered to create an IP based secure Internet connection back to an appropriately configured content management server 140, either hosted or one integrated into a communications network or a customer's own Intranet. Customer airlines may also publish new content for a specific eFlyBook 130, group of eFlyBooks 130, or all eFlyBooks 130 in their system to receive the new content the next time they initiate a connection over the Internet.

When a user selects a specific function (by hard or soft button activation), the display screen 210 is replaced with a screen that details the available documents or functions at a next level down in the hierarchy. Thus, eFlyBook 130 may have nested functionality until ultimately the desired document is opened and displayed.

The user interface may be page oriented and not windowed. For applications such as the OPC, returning to that function by pressing the OPC button 260 for instance, re-displays the OPC application from where it was left. Thus, there may be no need to re-navigate back to the specific pages on which the user was working.

The same may apply to documents. Once a document is opened and a specific page is viewed, the next time the document is opened, the same page may be displayed. There may also be a feature that allows immediate navigation to the table of contents as well.

With respect to the OPC button 260, the eFlyBook 130 may display an operational performance calculator known to one of skill in the art. In this manner, the pilot or crewmember can perform and store calculations essential to flight, such as fuel management, weight and balance, point-of-no-return, etc.

With respect to the “messages: button 250, a message can be a text note or bulletin that the airline wishes the pilot to be aware of before flight. For example, a user may wish to view a specific message related to an upcoming flight prior to departing. By pressing the “messages” button 250 (hard or soft), a new screen appears that displays the first page of available messages that have been received on the device. They are listed in order that they were received and have an associated icon and text indicator that shows if they have been viewed or not.

If more than 1 page of messages is available on the eFlyBook 130, there would be an indication at the bottom of the screen indicating how many pages of messages are available (i.e., 1 of 3). Note: there is a cursor-like indicator (vertical bar) that is always moved to indicate the selected function etc. In this case, until another message is selected, the bar indicates which message was last read.

The “document library” button 270 allows the user to access and interact with documents received from eFlyBook 130 downloads. A major functional capability of the eFlyBook 130 is to provide for the interaction with a wide variety of document types. Documents are generally organized into folders and sub-folders much as directory structures exist on a Windows PC. The eFlyBook 130 may use hierarchal navigation to ultimately display the desired document, for example.

There may also be many more document viewer specific functions, like zoom, pan, and annotation commands. A very important topic for in-depth discussion is that of document formatting, architecture, and publishing strategies. Due to the actual size of the eFlyBook 130 display area, it is important to design documents to incorporate attributes, such as page size, font, and imbedded hyperlinks, to be usable on the eFlyBook 130.

Another important factor is to consider publishing documents in small pieces, perhaps as chapters or sections in order to exploit the eFlyBook 130 type of content management capabilities that can transmit reduced size sections, or only the changed portions of documents instead of sending an entire document. This method may result in cost and time savings.

The “notes” button 280 may provide the user access and interaction with items received from wireless downloads, interactive capability for notes & forms, and to sign documents and upload them to dispatch. The eFlyBook 130 provides the capability to allow users to use a stylus to manually write on the device, just like paper. The eFlyBook 130 supports manually written text to be drawn over images and forms stored on the device.

Organized in folders, eFlyBook 130 may provide access to any number of templates in the form of images (tiff, jpg, gif and bmp files, etc.) as well as PDF files. The handwriting may be saved and associated to the corresponding template and can be modified again, deleted, or even marked for upload back to other systems using the eFlyBook 130.

There may also be a rich set of drawing functionality available such as selecting pen size and ink styles. Example of templates already developed include flight plan forms, meteorological information note pads, compliance certificates, and even blank lined paper for free form note taking. All user entered drawings may be stored associated to their originating template as well as time and date that they were saved.

There is much more low level functionality available like selecting pen size for marking notes, but is not documented in this disclosure

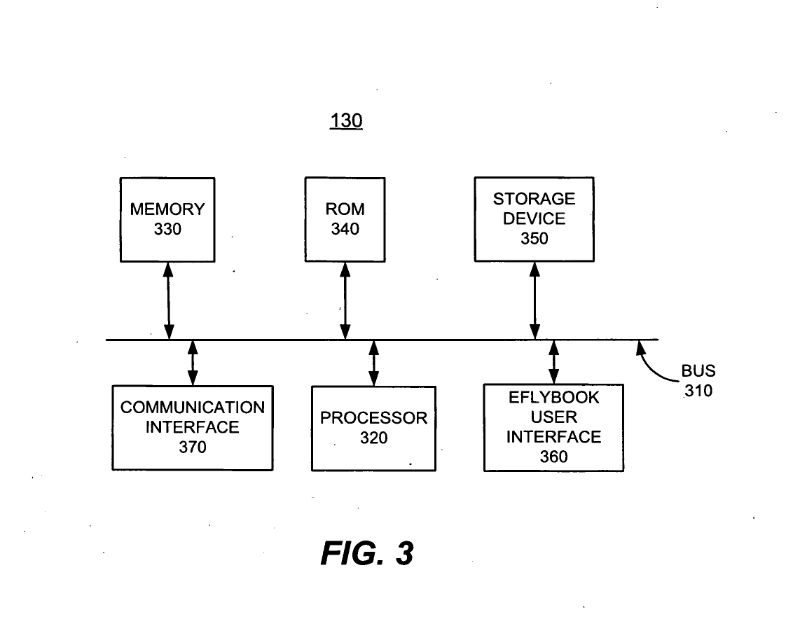

FIG. 3 illustrates a block diagram of an exemplary eFlyBook 130 in accordance with a possible embodiment of the disclosure. The eFlyBook 130 may include a bus 310, a processor 320, a memory 330, a read only memory (ROM 340, a storage device 350, an eFlyBook user interface 360, and a communication interface 370. The bus 310 may permit communication among the components of the eFlyBook 130.

The processor 320 may include at least one conventional processor or microprocessor that interprets and executes instructions. Memory 330 may be a random access memory (RAM or another type of dynamic storage device that stores information and instructions for execution by processor 320. Memory 330 may also include a read-only memory (ROM which may include a conventional ROM device or another type of static storage device that stores static information and instructions for processor 320.

The communication interface 370 may include any mechanism that facilitates communication via the network 110. For example, the communication interface 370 may include a modem. Alternatively, the communication interface 370 may include other mechanisms for assisting in communications with other devices and/or systems.

ROM 340 may include a conventional ROM device or another type of static storage device that stores static information and instructions for the processor 320. The storage device 350 may include any type of storage media, such as, for example, magnetic or optical recording media and its corresponding drive.

The eFlyBook user interface 360 may include one or more conventional input mechanisms that permit a user to input information, communicate with the eFlyBook 130, and/or present information to the user, such as an electronic display, microphone, touchpad, keypad, keyboard, mouse, pen, stylus, voice recognition device, buttons, one or more speakers, etc. Output mechanisms for the eFlyBook user interface 360 may include one or more conventional mechanisms that output information to the user, including a display, a printer, one or more speakers, or a medium, such as a memory, or a magnetic or optical disk and a corresponding disk drive.

The eFlyBook 130 may perform such functions in response to the processor 320 by executing sequences of instructions contained in a computer-readable medium, such as, for example, memory 330. Such instructions may be read into memory 330 from another computer-readable medium, such as a storage device or from a separate device via the communication interface 370.

The eFlyBook 130 illustrated in FIGS. 1 and 2 and the related discussion are intended to provide a brief, general description of a suitable communication and processing environment in which the invention may be implemented. Although not required, the invention will be described, at least in part, in the general context of computer-executable instructions, such as program modules, being executed by the eFlyBook 130, such as a communication server, communications switch, communications router, or general purpose computer, for example. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including personal computers, hand-held devices, multi-processor systems, microprocessor-based or programmable consumer electronics, and the like.

For illustrative purposes, the operation of the eFlyBook 130 will be described below in relation to the diagrams shown in FIGS. 1-3.

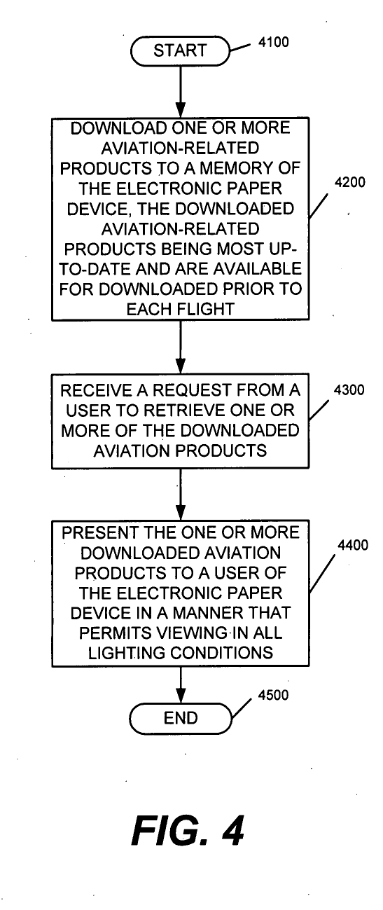

FIG. 4 is an exemplary flowchart illustrating one possible eFlyBook 130 implementation process in accordance with one possible embodiment of the disclosure. The process begins at step 4100 and continues to step 4200 where the eFlyBook 130 downloads one or more requested aviation products to an eFlyBook memory 330. The downloaded aviation products are advantageous because they are the most up-to-date aviation products commercially available and delivered to the eFlyBook 130 just prior to flight. At step 4300, the eFlyBook receives a request from a user to retrieve one or more of the downloaded aviation products. At step 4400, the eFlyBook 130 presents the one or more downloaded aviation products to the user so that the user may be able to view it in lighting conditions similar to that required by paper, including direct sunlight. In this manner the pilots and crew can view the documents in a safe and efficient manner. The process then goes to step 4500 and ends.

Note that the eFlyBook 130 may also receive input from a user and transmit that input to another device, server, etc., such as the content management server 140. For example, a pilot or crew member may use the stylus to mark up a form, write an electronic message, etc. and the eFlyBook 130 would then transmit the document to the appropriate device/server.

### SUMMARY

In summary, the eFlyBook 130 conveniently and easily provides flight crews with a robust set of capabilities targeted at reducing paper dependencies and streamlining acquisition of the information that they require to ensure safe operations.
The basic document interaction functionality provided can also be augmented by integrating other operational support applications, such as the OPC.
Airline operations may become more efficient as all the desired components can be implemented to take advantage of the automated content management system to deliver documents, software upgrades and database information.
The modular nature of the system architecture allows for new applications to be implemented as needed or desired. The folder structure/metaphor used in organizing and navigation can be expanded upon to add for functionality as new folders or items within, for instance, an application folder.
The internal memory capacity and various media support provided by the eFlyBook ensures that there is plenty of mass storage available for new data, information and applications.
The eFlyBook product is robust and provides a comprehensive portfolio of capabilities and many other uses/features may be integrated in the future.
The scalability and configurability of the system is a feature that allows the system to be tailored for different customers to accommodate their unique requirements easily.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the disclosed system each processing the content in various possible ways. It does not necessarily need to be one system used by all end users. Accordingly, the appended claims and their legal equivalents should only define the disclosure, rather than any specific examples given.

What is claimed is:

1. An electronic paper device for use by aircraft pilots and crew, comprising:
a communication interface that facilitates downloading of aviation-related documents, the aviation-related documents being and available for download prior to each flight;
a memory that stores the aviation-related documents;
a user interface that facilitates access and use of the aviation-related documents by a user; and
an electronic paper display that displays the aviation-related documents to the user in a manner that permits viewing in all lighting conditions similar to that required by paper, including bright sunlight.

2. The electronic paper device of claim 1, wherein the user interface includes a plurality of buttons which allow direct access to at least one of aviation-related documents, safety-of-flight materials, operational performance tools, aviation-related forms, and notes.

3. The electronic paper device of claim 1, further comprising:
a stylus for use with the electronic paper display, wherein marks on the electronic paper display made using the stylus are recorded and converted to one of electronic text and electronic drawings.

4. The electronic paper device of claim 3, wherein the electronic text and the electronic drawings are stored in the memory.

5. The electronic paper device of claim 1, further comprising:
a Wi-Fi transceiver coupled to the communication interface that facilitates downloading of aviation-related documents and transfer of data generated by the user of the electronic paper device.

6. The electronic paper device of claim 1, wherein the aviation-related documents are downloaded from a content management server, the content management server maintaining a repository of most-current aviation related documents.

7. The electronic paper device of claim 1, wherein the user interface provides access to point-of-sale tools, the point-of-sale tools enabling crew members to record and transmit point-of-sale transactions.

8. The electronic paper device of claim 1, further comprising:
a pop-up keyboard that facilitates the entering of information to the electronic paper device.

9. The electronic paper device of claim 1, wherein the aviation related products may include documents related to at least one of terminal approach procedures, airport facility directories, low and high enroute charts, Notices to Airmen, communication frequencies, aviation-related messages, and aviation checklists.

10. A method of providing aviation-related documents to pilots and crew of an aircraft using an electronic paper device having an electronic paper display, comprising:
downloading one or more aviation-related products to a memory of the electronic paper device, wherein the downloaded aviation-related products are up-to-date and available for download prior to each flight;
receiving a request from a user to retrieve one or more of the downloaded aviation-related products; and
presenting the one or more downloaded aviation-related products to a user of the electronic paper device in a manner that permits viewing in all lighting conditions similar to that required by paper, including bright sunlight.

11. The method of claim 10, further comprising:
receiving input from the user via a user interface, the user interface including a plurality of buttons which allow direct access to at least one of aviation-related documents, safety-of-flight materials, operational performance tools, aviation-related forms, and notes.

12. The method of claim 10, further comprising:
receiving input from the user via a stylus for use with the electronic paper display, wherein marks on the electronic paper display made using the stylus are recorded and converted to one of electronic text and electronic drawings.

13. The method of claim 12, wherein the electronic text and the electronic drawings are stored in the memory.

14. The method of claim 10, wherein the aviation-related documents are downloaded using a Wi-Fi transceiver coupled to the communication interface, the Wi-Fi transceiver facilitating transfer of data generated by the user of the electronic paper device.

15. The method of claim 10, wherein the aviation-related documents are downloaded from a content management server, the content management server maintaining a repository of most-current aviation related documents.

16. The method of claim 10, further comprising:
receiving point-of-sale transaction information; and
transmitting point-of-sale transaction information to locations outside of the aircraft.

17. The method of claim 10, further comprising:
receiving input from the user via a pop-up keyboard that facilitates the entering of information to the electronic paper device.

18. The method of claim 10, wherein the aviation related products may include documents related to at least one of terminal approach procedures, airport facility directories, low and high enroute charts, Notices to Airmen, communication frequencies, aviation-related messages, and aviation checklists.

19. A user interface for an electronic paper device for use by aircraft pilots and crew, comprising:
an electronic paper display that displays aviation-related documents to the user in a manner that permits viewing in all lighting conditions; and
a plurality of buttons which allow direct access to at least one of aviation-related documents, safety-of-flight materials, operational performance tools, aviation-related forms, and notes.

20. The user interface of claim 19, further comprising:
a stylus for use with the electronic paper display, wherein marks on the electronic paper display made using the stylus are recorded and converted to one of electronic text and electronic drawings.
